(19) United States
(12) Patent Application Publication
(10) Pub. No.: US 2010/0247719 A1
(43) Pub. Date: Sep. 30, 2010

(54) PREPACKAGED FOOD KIT

(76) Inventor: Donald G. Everard, Maple Valley, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/795,536

(22) Filed: Jun. 7, 2010

Related U.S. Application Data
(63) Continuation of application No. 11/344,536, filed on Jan. 30, 2006, now abandoned.

(51) Int. Cl. A23G 1/00; A23G 3/00; B65D 81/32

(52) U.S. Cl. 426/120; 426/128; 426/404; 426/397

(57) ABSTRACT

A prepackaged food kit (20) for making or assembling s'mores generally includes a base tray (22) defining at least one compartment (24). The at least one compartment including a plurality of biscuits (30), a plurality of confection pieces (32), and a plurality of marshmallows (34). The kit also includes a top (40) fitted and sealed to the base tray.

### CROSS-REFERENCE TO RELATED APPLICATION

This application is a continuation of U.S. patent application Ser. No. 11/344,536, filed Jan. 30, 2006, which is incorporated herein by reference.

### TECHNICAL FIELD

Embodiments of the present disclosure relate generally to prepackaged food kits and, more specifically, to prepackaged food kits for making or assembling s'mores.

### BACKGROUND

Campers sitting around a fire or families enjoying a backyard barbeque often take pleasure in creating a dessert known as a “s'more.” A s'more is an assembled dessert sandwich, which generally includes a toasted marshmallow and a piece of chocolate sandwiched typically between two graham crackers.

Making or assembling s'mores requires planning and preparation, and can often be expensive. For example, one must buy a separate package of each of the necessary ingredients, including a box of graham crackers, a bag of marshmallows, and individual chocolate bars. These packages can be large and bulky, and oftentimes provide ingredients in excess of those required for making a desired number of s'mores. Because there are never an equal number of each of the ingredients, many of one or two types of the ingredients (such as graham crackers and marshmallows) are either left over for inconvenient storage or thrown away. In addition, the differing shapes and sizes of commercially available graham crackers and chocolate bars are not designed for or conducive to making s'mores.

Therefore, there exists a need for a convenient and inexpensive prepackaged s'mores kit with sufficient quantities of each ingredient to optimize s'more-making and minimize ingredient waste.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

In accordance with one embodiment of the present disclosure, a prepackaged food kit for making or assembling s'mores is provided. The kit includes a base tray defining at least one compartment. The kit further includes the at least one compartment including a plurality of biscuits, a plurality of confection pieces, and a plurality of marshmallows. The kit further includes a top fitted and sealed to the base tray.

In accordance with other embodiments of the present disclosure, the kit includes a base tray defining first, second, and third compartments. The first compartment includes a plurality of biscuits, the second compartment includes a plurality of confection pieces, and the third compartment includes a plurality of marshmallows.

In accordance with other embodiments of the present disclosure, a method of assembling a prepackaged food kit for making or assembling s'mores is provided. The method includes obtaining a base tray defining at least one compartment, and inserting biscuits, confection pieces, and marshmallows within the at least one compartment. The method further includes fitting a top to hermetically seal the at least one compartment from the atmosphere, and purifying the at least one compartment.

### BRIEF DESCRIPTION OF THE DRAWINGS

The foregoing aspects and many of the attendant advantages of this disclosure will become more readily appreciated by reference to the following detailed description, when taken in conjunction with the accompanying drawings, wherein:

FIG. 1 is a perspective view of a prepackaged s'mores kit in accordance with one embodiment of the present disclosure;

FIG. 2 is an exploded view of the s'mores kit of FIG. 1;

FIG. 3 is an elevation view of the s'mores kit of FIG. 1; and

FIG. 4 is a cross-sectional, side view of the s'mores kit of FIG. 1, taken along lines 4-4 in FIG. 3.

### DETAILED DESCRIPTION OF THE EXEMPLARY EMBODIMENTS

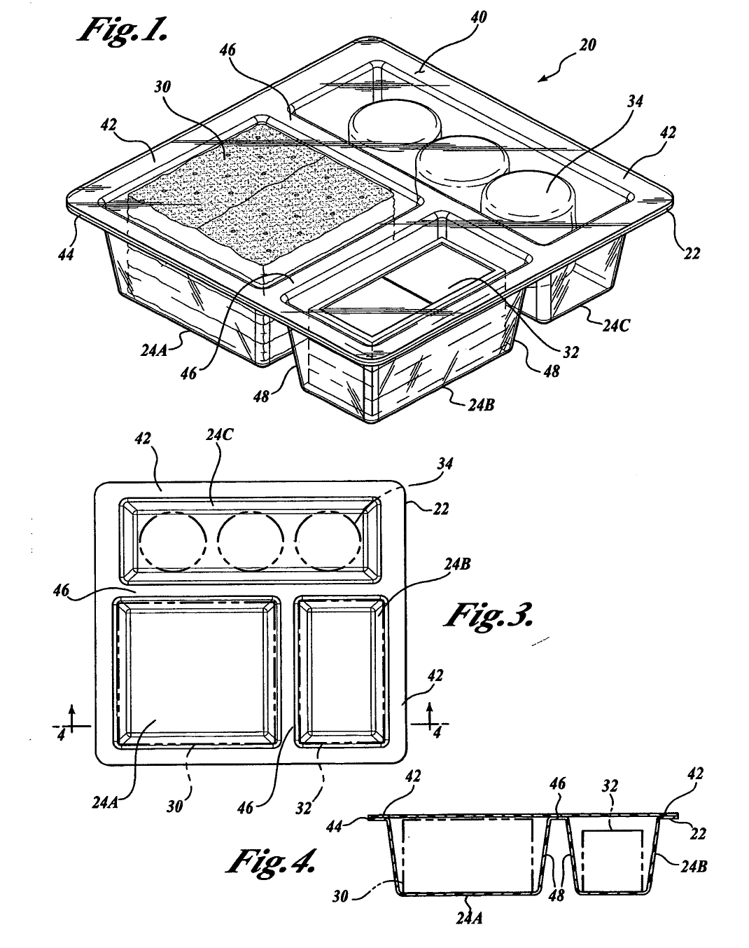

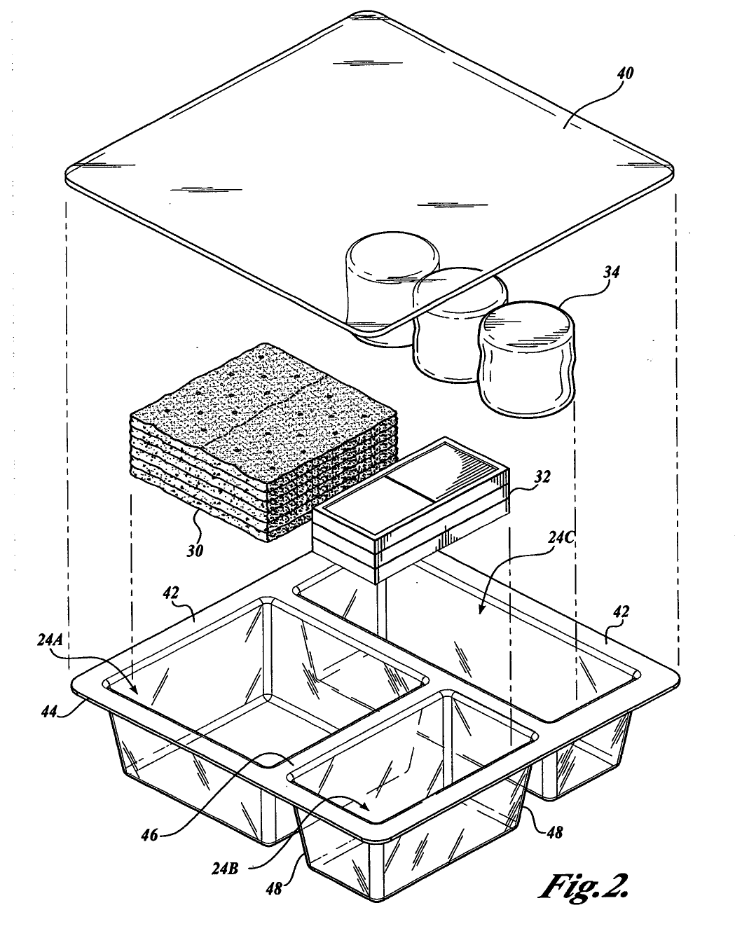

Embodiments of the present disclosure are generally directed to a prepackaged kit for making or assembling s'mores. A prepackaged kit for making or assembling s'mores 20 constructed in accordance with one embodiment of the present disclosure may be best understood by referring to FIGS. 1-4. As shown in FIGS. 1 and 2, the kit 20 generally includes a base tray 22, having at least one recessed compartment 24. The at least one recessed compartment 24 contains one or more s'more ingredients, including graham crackers or biscuits 30, chocolate or confection pieces 32, and marshmallows 34. The kit 20 also includes a top 40, which is designed and configured to be fitted and sealed to the base tray 22.

In the illustrated embodiment of FIGS. 1-4, the base tray 22 is constructed of plastic or other suitable material and includes a base tray body defining three compartments (first, second, and third compartments 24A, 24B, and 24C) and a flange 44 outwardly extending from the top periphery surfaces 42 thereof. Each of the compartments 24A, 24B, and 24C contain individual s'more ingredients 30, 32, and 34, respectively. In that regard, the first compartment 24A contains graham crackers or biscuits 30, the second compartment 24B contains chocolate or confection pieces 32, and the third compartment 24C contains marshmallows 34.

Although the illustrated embodiment includes three compartments 24A, 24B, and 24C, it should be appreciated that the embodiments of kits 20 may include base trays 22 with a greater or lesser number of compartments for containing s'more ingredients 30, 32, and 34, and thus, these embodiments are contemplated to be within the scope of the disclosure. As a nonlimiting example, a base tray 22 having less than three compartments may include, for example, one compartment containing a plurality of individual, airtight packages for hermetically sealing the ingredients, such as biscuits 30, confection pieces 32, and marshmallows 34, from one another.

It should further be appreciated that the kit 20 may optionally include a utensil (such as a stick or skewer) to roast the marshmallow over an open fire, a tray for heating the s'more in the microwave, a moist towelette for cleaning up sticky fingers, or any other additional component, whether a food component or nonfood component, for product convenience and/or enjoyment. Moreover, those skilled in the art will recognize that similar types of kits having base trays with additional compartments for containing additional components, such as those listed above, is within the scope of the disclosure.

The top 40 is a film or sheet material that can be printed upon, if desired. As nonlimiting examples, the top 40 may be constructed from plastic, foil, waxed paper, or other flexible, nonbreathable films. Although the top 40 of the illustrated embodiment of FIG. 1 is a flexible material, it should be appreciated that the top 40 also may be constructed from nonflexible plastics, metals, or other materials, so as to create a “hard” top for the kit 20. The top 40 is air-tightly sealed to the flanges 44 and/or the top periphery surfaces 42 of the base tray 22 for hermetically sealing the contents of the kit 20 from the atmosphere. The top 40 can be further sealed to the base tray 22 at top surfaces 46 of walls 48 that separate one compartment 24 from another in order to hermetically seal the contents of the kit 20 from one compartment to another (see FIG. 4). As a nonlimiting example, as best seen in FIG. 1, the top 40 is peelably sealed to the flanges 44 and/or the top periphery surfaces 42 of the base tray 22 and at the top surfaces 46 of the separation walls 48 to hermetically seal compartments 24A, 24B, and 24C from the atmosphere and from one another.

The kit 20, when sealed by the top 40, can be gas flushed. To additionally ensure freshness of the food ingredients 30, 32, and 34, individual packages containing biscuits 30, confection pieces 32, or marshmallows 34 could be gas flushed or vacuum sealed and placed in compartments 24A, 24B, and 24C of the base tray 22 in forming the kit 20. The top 40 may be of a resealable design or configuration, such that after the kit 20 has been opened, the top 40 can be resealed.

In embodiments of the present disclosure, the number of biscuits 30, confection pieces 32, and marshmallows 34 in a kit 20 in accordance with the present disclosure are provided in sufficient quantities to make a specified number of s'mores. For example, the biscuits, confection pieces, and marshmallows may be in a ratio of 2:1:1 to make a s'more or a plurality of s'mores without leaving any leftover ingredients. In the illustrated embodiment of FIGS. 1-4, the kit 20 includes six biscuits 30 in the first compartment 24A, three confection pieces 32 in the second compartment 24B, and three marshmallows 34 in the third compartment 24C. In another nonlimiting example, the kit may include eight biscuits, four confection pieces, and four marshmallows. Although the ratio of the illustrated embodiment of FIGS. 1-4 is 2:1:1 of biscuits to confection pieces to marshmallows, it should be appreciated that other ratios and/or numbers of ingredients are within the scope of the present disclosure. As a nonlimiting example, the confection lover (e.g., the chocolate lover) might desire a kit containing a ratio of 2:2:1 of biscuits to chocolate or confection pieces to marshmallows.

The s'more ingredients of the kit 20 will now be discussed in greater detail. The biscuits 30 are generally sized to make a small sandwich, and the confection pieces 32 and the marshmallows 34 are also generally sized to be smaller than and received between the biscuits 30 forming the s'more sandwich. The biscuits 30 may be of any variety of biscuit, including, but not limited to, graham crackers, cookies, wafers, crackers, shortbreads, or any other similar food product used to form a s'more sandwich. The marshmallows 34 may be of any flavor, variety, or shape of individual marshmallows, including, but not limited to, conventional campfire marshmallows which can be roasted on a stick.

The confection pieces 32 may be of any variety of chocolate confection, including white chocolate, dark chocolate, milk chocolate, or any mix thereof. It will further be appreciated that confection pieces having non-chocolate ingredients are also within the scope of the disclosure. As nonlimiting examples, the confection pieces may include chocolate mixed with peanut butter, nut, caramel, nougat, wafer, fruits, fruit preserves, fudge, marzipan, nuts and nut butters, any other variety of ingredient or confection, or any mixtures thereof. In addition, it should be appreciated that the other non-chocolate confection pieces are also within the scope of the embodiment. As nonlimiting examples, the non-chocolate confection pieces may include peanut butter, nut butter, caramel, nougat, wafer, fruits, fruit preserves, fudge, marzipan, nuts and nut butters, any other nonconfection pieces, or any mixtures thereof. In general, the confection pieces 32 generally have the attributes of remaining substantially hard at room temperature, and melted when heated (e.g., in the nature of milk chocolate).

Assembly of the kit 20 in accordance with one embodiment of the present disclosure is best described with reference to FIG. 2. First, the food ingredients 30, 32, and 34 of the kit 20 are inserted within the recessed compartments 24A, 24B, and 24C of the base tray 22. Specifically, biscuits 30 are placed within the first compartment 24A, confection pieces 32 are placed within the second compartment 24B, and marshmallows 34 are inserted within the third compartment 24C. Additional components, such as those discussed above (not shown), also may be inserted within compartments 24A, 24B, and 24C. The top 40 is fitted and sealed to the flanges 44 and/or the top periphery surfaces 42 of the base tray 22. The top 40 can be further sealed to the base tray 22 at a top surface 46 of walls 48 separating one compartment from another in order to hermetically seal the contents of the kit 20 from one compartment to another. The recessed compartments 24A, 24B, and 24C can then be gas-flushed, vacuum-sealed, or otherwise purified for food preservation, to increase the shelf life of the perishable food ingredients within the kit 20.

In use, the kit 20 may be opened by peeling back, or otherwise releasing, the hermetically sealed top 40 from the base tray 22. The user then obtains two biscuits 30, one confection piece 32, and one marshmallow 34 from the compartments 24A, 24B, and 24C of the base tray 22. The user places a heated or unheated confection piece 32 between the two biscuits 30. The user heats a marshmallow 34 to a sticky, soft, and pliable consistency and places the marshmallow 34 on top of the confection piece 32 between the two biscuits 30. The user then presses the biscuits 30 toward one another to sandwich the confection piece 32 and marshmallow 34 therein and provide a s'more sandwich dessert.

The user can use any remaining ingredients to make and assemble additional s'mores. If the top 40 is a resealable top, the user can reseal the top 40 to the base tray 22 to further preserve any remaining ingredients.

While the marshmallow 34 is generally heated by toasting over a campfire, heating of one or more of the s'more ingredients 30, 32, and 34 may be performed in any type of conventional food heating device. Such conventional food heating devices include, but are not limited to, convection or microwave ovens, gas or electric stovetops, charcoal or gas grills, campfires, or cooking blowtorches commonly used for browning, or any other conventional food heating device.

While the preferred embodiment of the present disclosure has been illustrated and described, it will be appreciated that various changes can be made therein without departing from the spirit and scope of the disclosure.

1. A prepackaged food kit for making or assembling s'mores, the kit comprising:
(a) a base tray defining at least one compartment;
(b) the at least one compartment including a plurality of biscuits;
(c) the at least one compartment including a plurality of confection pieces;
(d) the at least one compartment including a plurality of marshmallows; and
(e) a top fitted and sealed to the base tray.

2. The prepackaged food kit of claim 1, wherein the top hermetically seals the at least one compartment from the atmosphere.

3. The prepackaged food kit of claim 1, wherein the plurality of biscuits, confection pieces, and marshmallows are in sufficient quantities to make a specified number of s'mores.

4. The prepackaged food kit of claim 1, wherein the ratio of a plurality of crackers to a plurality of confection pieces to a plurality of marshmallows is 2:1:1.

5. The prepackaged kit of claim 4, wherein the at least one compartment includes six biscuits, three confection pieces, and three marshmallows.

6. The prepackaged food kit of claim 4, wherein the first compartment includes eight biscuits, wherein the second compartment includes four confection pieces, and wherein the third compartment includes four marshmallows.

7. The prepackaged food kit of claim 1, wherein the ratio of a plurality of crackers to a plurality of confection pieces to a plurality of marshmallows is 2:2:1.

8. The prepackaged kit of claim 1, wherein the biscuits are graham crackers.

9. The prepackaged food kit of claim 1, wherein the confection pieces are chocolate pieces.

10. The prepackaged food kit of claim 1, wherein the base tray defines at least two compartments.

11. The prepackaged food kit of claim 10, wherein the top hermetically seals the at least two compartments from the atmosphere and from each other.

12. A prepackaged food kit for making or assembling s'mores, the kit comprising:
(a) a base tray defining first, second, and third compartments;
(b) the first compartment including a plurality of biscuits;
(c) the second compartment including a plurality of confection pieces;
(d) the third compartment including a plurality of marshmallows; and
(e) a top fitted and sealed to the base tray.

13. A method of assembling a prepackaged food kit for making or assembling s'mores, the method comprising:
(a) obtaining a base tray defining at least one compartment;
(b) inserting biscuits, confection pieces, and marshmallows within the at least one compartment;
(c) fitting a top to hermetically seal the at least one compartment from the atmosphere; and
(d) purifying the at least one compartment.

14. The method of claim 13, wherein purifying the at least one compartment includes gas-flushing the compartment.

15. The method of claim 13, wherein purifying the at least one compartment includes vacuum-sealing the compartment.
